(19) United States
(12) Patent Application Publication
(10) Pub. No.: US 2024/0136594 A1
(43) Pub. Date: Apr. 25, 2024

(54) ALL-SOLID-STATE BATTERY AND MANUFACTURING METHOD OF THE SAME

(71) Applicant: SAMSUNG SDI CO., LTD., Yongin-si (KR)

(72) Inventor: Jihyoung PARK, Yongin-si (KR)

(21) Appl. No.: 18/381,816

(22) Filed: Oct. 18, 2023

(30) Foreign Application Priority Data
Oct. 19, 2022 (KR) 10-2022-0135838

(51) Int. Cl. H01M 10/0585; H01M 50/105; H01M 50/202; H01M 50/54

(52) U.S. Cl. CPC H01M 10/0585; H01M 50/105; H01M 50/202; H01M 50/54

(57) ABSTRACT

An all-solid-state battery, including an electrode stacked body in which a positive electrode plate, a solid electrolyte layer, and a negative electrode plate are stacked, a gasket provided as a pair in a stacking direction on an outer edge of the electrode stacked body, and a pouch including a pair of pouch sheets on opposite surfaces of the electrode stacked body and opposite surfaces of the gasket, wherein the electrode stacked body has a first symmetrical structure that is vertically symmetrical with respect to a central line of the stacking direction at an edge portion in the gasket and the pouch.

### CROSS-REFERENCE TO RELATED APPLICATION

This application claims priority to and the benefit of Korean Patent Application No. 10-2022-0135838, filed at the Korean Intellectual Property Office on Oct. 20, 2022, the entire contents of which are incorporated herein by reference.

### BACKGROUND

### 1. Field

Embodiments relate to an all-solid-state battery and a manufacturing method thereof. More particularly, embodiments relate to an all-solid-state battery manufactured by applying a warm isostatic press (WIP) process and a manufacturing method thereof.

### 2. Description of the Related Art

An all-solid-state battery includes a positive electrode plate, a solid electrolyte layer, and a negative electrode plate. The solid electrolyte layer is a medium that conducts lithium ions. In a case of a lithium precipitation all-solid-state battery, lithium ions are deposited to a metal on the negative electrode plate and are accumulated, and a lithium metal is deposited on the negative electrode plate during charging regardless of the presence or absence of an active material in the negative electrode plate.

### SUMMARY

Embodiments are directed to an all-solid-state battery, including an electrode stacked body in which a positive electrode plate, a solid electrolyte layer, and a negative electrode plate are stacked, a gasket provided as a pair in a stacking direction on the outer edge of the electrode stacked body, and a pouch formed by sealing a pair of pouch sheets provided on both surfaces of the electrode stacked body and both surfaces of the gasket, wherein the electrode stacked body forms a first symmetrical structure that is vertically symmetrical with respect to a central line of the stacking direction at an edge portion in the gasket and the pouch.

In embodiments the pouch may form a second symmetrical structure that is vertically symmetrical with the central line as a reference so as to correspond to the first symmetrical structure at a corresponding portion facing the edge portion.

In embodiments the pouch may include a recessed portion of a concave structure on both surfaces of the gasket.

In embodiments the electrode stacked body may have a slope of a predetermined angle (0) from the upper and lower surfaces adjacent to the inner surface of the pouch toward the central line portion.

In embodiments the positive electrode plate may be at the center of the electrode stacked body, and the positive electrode tab connected to the positive electrode plate may be between the gaskets formed as a pair by maintaining a plate shape on the edge portion.

In embodiments the negative electrode plate may be on both surfaces of the electrode stacked body, and the negative electrode tab connected to the negative electrode plate may be bent into the second symmetrical structure at the edge portion and between the gaskets.

Embodiments are directed to a manufacturing method of an all-solid-state battery, including preparing an electrode stacked body in which a positive electrode plate, a solid electrolyte layer, and a negative electrode plate are stacked, disposing the electrode stacked body in a first penetration hole of a first frame having the first penetration hole corresponding to the outer edge of the electrode stacked body, disposing a process sheet on both surfaces of the electrode stacked body and the first frame, packaging and sealing the electrode stacked body and the first frame to form a process pouch, and disposing and mutually assembling a pair of second frames having second penetration holes on both surfaces of the process pouch to perform a warm isostatic press (WTP).

In embodiments the edge portion of the electrode stacked body may be pressurized with a first symmetrical structure that may be vertically symmetrical with respect to the central line of the stacking direction.

In embodiments the process corresponding portion facing the edge portion in the process pouch may be pressurized with a second symmetrical structure that may be vertically symmetrical with the central line as a reference so as to correspond to the first symmetrical structure.

In embodiments a first gap may be formed between the inner surface of the first penetration hole and the outer edge of the electrode stacked body.

In embodiments the edge portion of the electrode stacked body may be pressurized with a slope of a predetermined angle (0) with respect to the central line portion by receiving the warm isostatic press (WIP) from the upper and lower sides adjacent to the inner surface of the second frame of the process pouch.

### BRIEF DESCRIPTION OF THE DRAWINGS

Features will become apparent to those of skill in the art by describing in detail exemplary embodiments with reference to the attached drawings in which:

FIG. 1 shows a cross-sectional view of a charge state of an electrode stacked body forming an all-solid-state battery according to an embodiment;

FIG. 2 shows a top plan view of a gasket forming an all-solid-state battery according to an embodiment;

FIG. 3 shows a top plan view of an assembly in which the gasket of FIG. 2 is combined on the electrode stacked body of FIG. 1;

FIG. 4 shows a cross-sectional view of a state taken along a line IV-IV of FIG. 3 by disposing a pouch on the assembly of FIG. 3;

FIG. 5 shows a cross-sectional view of a state before sealing the assembly and the pouch in the state of FIG. 4;

FIG. 6 shows a cross-sectional view showing a state after sealing the assembly and the pouch in the state of FIG. 5;

FIG. 7 shows a perspective view of a first step and a second step for disposing a prepared electrode stacked body in a first penetration hole of a first frame in a manufacturing method of an all-solid-state battery according to an embodiment;

FIG. 8 shows a perspective view of a third step of packing and sealing an electrode stacked body in the state of FIG. 7, and a first frame with a process pouch;

FIG. 9 shows an exploded perspective view of a state before mutually fastening second frames among a fourth step in which a warm isostatic press is performed by disposing a pair of second frames having second penetration holes on both sides of a process pouch in the state of FIG. 8 and fastening them to each other;

FIG. 10 is an image showing a symmetrical structure at an edge portion (equally applied to an electrode stacked body in a pouch in an all-solid-state battery to which the electrode stacked body is applied) of an electrode stacked body in a process pouch in a state in which the fourth step of FIG. 9 is completed; and

FIG. 11 is a graph comparing characteristic evaluation (battery capacity dominance) for an all-solid-state battery according to an embodiment in which an electrode stacked body forms a symmetrical structure on an edge portion and a comparative example forming an asymmetrical structure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

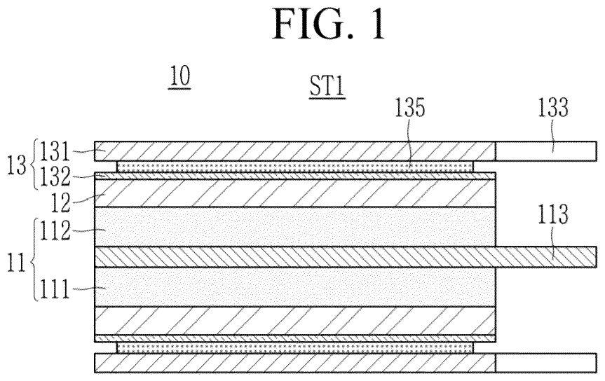

FIG. 1 shows a cross-sectional view of a charge state of an electrode stacked body forming an all-solid-state battery according to an embodiment. Referring to FIG. 1, an electrode stacked body 10 of an all-solid-state battery of an embodiment may include a positive electrode plate 11, a solid electrolyte layer 12, and a negative electrode plate 13 on one side of the solid electrolyte layer 12.

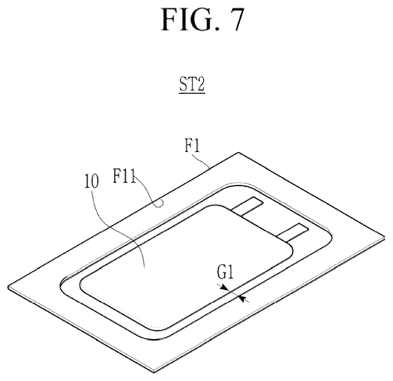

In the electrode stacked body 10, the solid electrolyte layer 12 may be on one side of the positive electrode plate 11, and the negative electrode plate 13 may be on one side of the solid electrolyte layer 12. The electrode stacked body 10 may form a unit cell as a bi-cell by the stacking structure of the positive electrode plate 11, the solid electrolyte layer 12, and the negative electrode plate 13. The electrode stacked body 10 may be manufactured by the manufacturing method of the all-solid-state battery to be described in FIG. 7 to FIG. 10 below. That is, the electrode stacked body 10 may be a state in which a warm isostatic press (WIP) has been performed.

The positive electrode plate 11 may be formed by coating a positive electrode mixture layer 112 on a positive electrode collector 111. The positive electrode plate 11 may include a positive electrode collector 111 made of aluminum and a positive electrode mixture layer 112 formed by coating a slurry to both surfaces thereof. That is, during charging and discharging, the positive electrode mixture layer 112 may enable entering and exiting of lithium ions. The positive electrode collector 111 may not include the positive electrode mixture layer 112, and further may include a positive electrode tab 113 that may protrude more laterally than the solid electrolyte layer 12.

The negative electrode plate 13 may include a negative electrode collector 131 made of stainless steel or nickel-coated copper (Ni-coated Cu) and a negative electrode mixture layer 132 formed by coating a slurry to one surface thereof. For convenience, the negative electrode mixture layer 132 is shown here, but the negative electrode mixture layer 132 may not be present. In this case, the lithium precipitation layer 135 that may be precipitated acts as a negative electrode mixture layer. The negative electrode collector 131 may not include the negative electrode mixture layer 132 and may further include a negative electrode tab 133 protruding more laterally than the solid electrolyte layer 12.

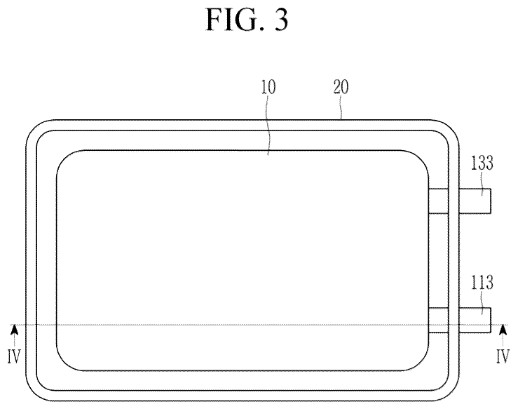

The positive electrode tab 113 and the negative electrode tab 133, as shown in FIG. 3, may be drawn out in parallel to one side of the electrode stacked body 10.

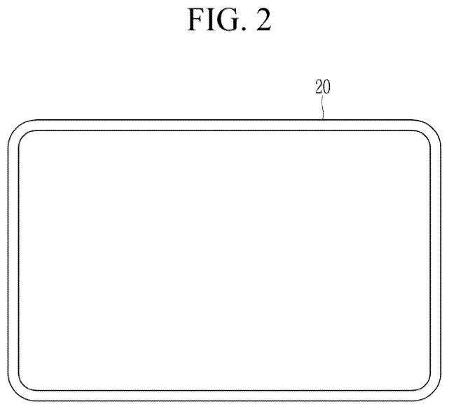

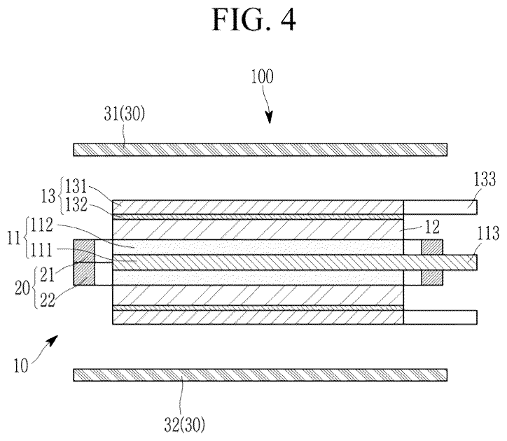

FIG. 2 shows a top plan view of a gasket forming an all-solid-state battery according to an embodiment. FIG. 3 shows a top plan view of an assembly in which the gasket of FIG. 2 is combined on the electrode stacked body of FIG. 1. FIG. 4 shows a cross-sectional view of a state taken along a line III-III of FIG. 3 by disposing a pouch on the assembly of FIG. 3.

Referring to FIG. 1 to FIG. 4, the all-solid-state battery 100 of an embodiment may include a gasket 20 and a pouch 30. The gasket 20 may include a first gasket member (21; upper side in the drawing) and a second gasket member (22; lower side in the drawing) provided in pairs in the stacking direction on the outside of the electrode stacked body 10 and overlapped with each other.

That is, the first gasket member 21 may be on the upper surface of the positive electrode tab 113, and the second gasket member 22 may be on the lower surface of the positive electrode tab 113. If one positive electrode tab 113 is provided with two negative electrode tabs 133, one of the two negative electrode tabs 133 may be disposed at the lower side of the first gasket member 21, and the other may be disposed at the upper side of the second gasket member 22 so that they are overlapped and connected. For example, as illustrated in FIG. 4, each of the first gasket member 21 and the second gasket member 22 may be between the positive electrode tab 113 and a corresponding negative electrode tab 133. In this way, the electrode stacked body 10 and the gasket 20 may be coupled to each other to form one assembly.

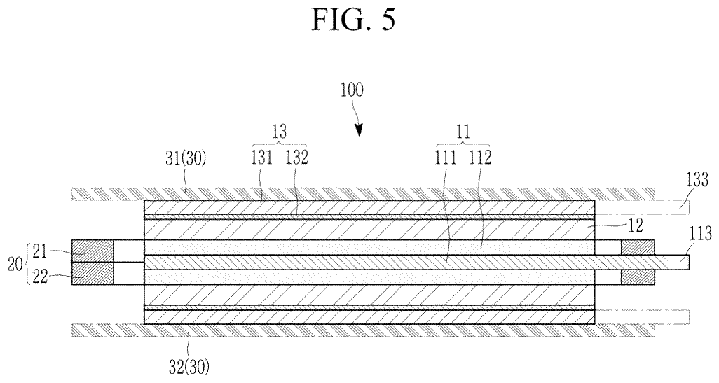

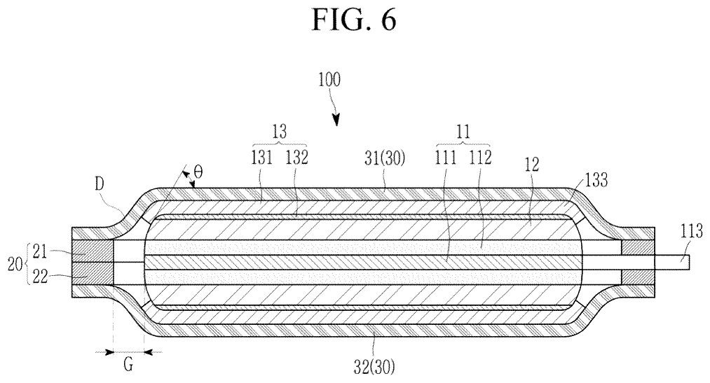

FIG. 5 shows a cross-sectional view of a state before sealing an assembly and a pouch in the state of FIG. 4. FIG. 6 shows a cross-sectional view of a state after sealing an assembly and a pouch in the state of FIG. 5.

Referring to FIG. 4 and FIG. 6, a pouch 30 may include a pair of first pouch sheet 31 and second pouch sheet 32 on both sides of the assembly. The first pouch sheet 31 and the second pouch sheet 32 may be on both sides of the electrode stacked body 10 and both sides of the gasket 20 to seal the outer shell, thereby forming a sealing structure embedding the electrode stacked body 10.

The first pouch sheet 31, the second pouch sheet 32, and the gasket 20 may form the exterior of the all-solid-state battery, and positive electrode tab 113 and the negative electrode tab 133 may be drawn out to the exterior of the gasket 20 and the pouch 30.

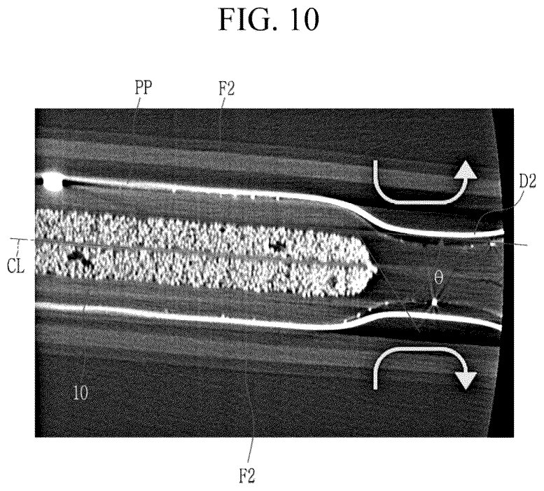

The electrode stacked body 10 may form a first symmetrical structure with respect to the central line CL, see FIG. 10, of the stacking direction at the edge portion in the gasket 20 and the pouch 30. That is, the edge portion of the electrode stacked body 10 may form the first symmetrical structure that is, e.g., vertically symmetrical with the central line CL as a reference. For example, the central line CL may extend along a direction parallel to positive electrode tab 113.

With respect to the positive electrode collector 111 as the center, the positive electrode mixture layer 112 and the solid electrolyte layer 12 may form a round structure on one surface of the positive electrode collector 111, and the positive electrode mixture layer 112 and the solid electrolyte layer 12 may form a symmetrical round structure on the other surface of the positive electrode collector 111. Therefore, the first symmetrical structure may be formed on both surfaces of the positive electrode collector 111.

The electrode stacked body 10 and the edge portion may have a slope of a predetermined angle θ from the upper and lower surfaces adjacent to the inner surface of the pouch 30 toward the central line CL. That is, the tangent to the round structure formed by the positive electrode mixture layer 112 and the solid electrolyte layer 12 on each surface of the positive electrode collector 111 may form the slope of the angle θ. Therefore, the first symmetrical structure that may be symmetrical with the slope of the angle θ may be formed on both surfaces of the positive electrode collector 111.

Accordingly, the pouch 30 embodying the electrode stacked body 10 may form a second symmetrical structure corresponding to the first symmetrical structure at a corresponding portion facing the edge portion of the electrode stacked body 10. That is, the pouch 30 may form the second symmetrical structure that is, e.g., vertically symmetrical with the central line CL as a reference. For example, the central line CL may extend along a direction parallel to the positive electrode tab 113.

Due to the first and second symmetrical structures, the edge portion of the electrode stacked body 10 may maintain a connected state without being separated from the electrode stacked body 10, so that charging and discharging may be performed. That is, the embodiment may maintain a battery capacity, and an internal resistance IR may appear lower.

This is differentiated from the difficulty of charging and discharging due to a partial separation of the edge portion from the electrode stacked body when a crack occurs as the edge portion of the electrode stacked body forms an asymmetrical structure in a comparative example. That is, the comparative example may bring about the deteriorated battery capacity as much as the separated non-symmetrical edge portion, and higher internal resistance IR appears.

The pouch 30 may form a concave structure on both surfaces of the gasket 20. Due to an interval G between the gasket 20 and the end of the electrode stacked body 10, the pouch 30 may form a structure having a recessed portion D that is recessed toward the central line CL. The negative electrode collector 131 may move away from the positive electrode collector 111 while being bent along the inner surface of the recessed portion D within the recessed portion D, thereby preventing an internal short circuit.

In the all-solid-state battery, the positive electrode plate 11 may be in the center of the electrode stacked body 10, and the positive electrode tab 113 connected to the positive electrode plate 11 may be connected to the edge portion of the electrode stacked body 10 to maintain the plate shape and may be between the first gasket member 21 and the second gasket member 22 formed as a pair.

The negative electrode plate 13 may be on both surfaces of the electrode stacked body 10, and the negative electrode tab 133 connected to the negative electrode plate 13 may be bent into the second symmetrical structure on the edge portion and may be between the first gasket member 21 and the second gasket member 22, corresponding to the upper side and the lower side, respectively.

Again, referring to FIG. 1, the lithium precipitation layer 135 may not be formed in the discharge state, but in the charged state, lithium ion from the positive electrode plate 11 may pass through the solid electrolyte layer 12 and it may be formed by the precipitation on one surface of the negative electrode collector 131. During the discharge, lithium ions of the lithium precipitation layer 135 may be dissociated, pass through the solid electrolyte layer 12 and move to the positive electrode plate 11, so that the lithium precipitation layer 135 disappears.

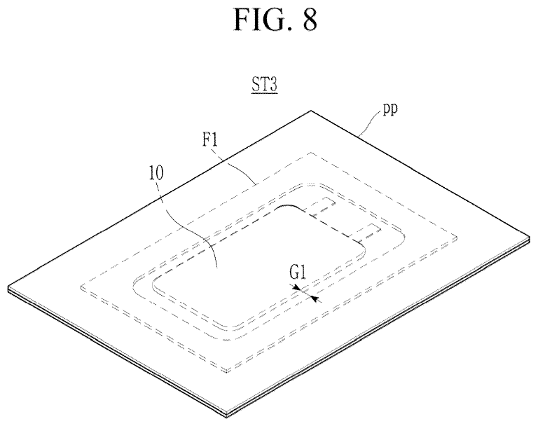

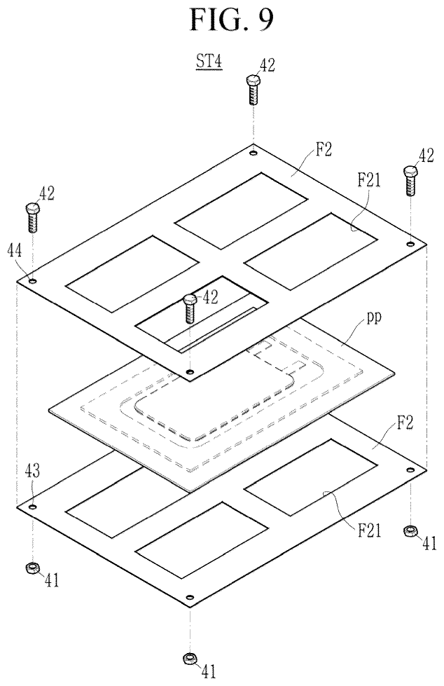

Hereinafter, a method for manufacturing the all-solid-state battery 100 as in an embodiment will be described. FIG. 7 shows a perspective view of a first step and a second step for disposing a prepared electrode stacked body in a first penetration hole of a first frame in a manufacturing method of an all-solid-state battery according to an embodiment. FIG. 8 shows a perspective view of a third step of packing and sealing an electrode stacked body in the state of FIG. 7 and a first frame with a process pouch. FIG. 9 shows an exploded perspective view of a state before mutually fastening second frames among a fourth step in which a warm isostatic press may be performed by disposing a pair of second frames having second penetration holes on both sides of a process pouch in the state of FIG. 8 and fastening them to each other.

Referring to FIG. 7 to FIG. 9, the manufacturing method of the all-solid-state battery according to an embodiment may include a first step ST1, a second step ST2, a third step ST3, and a fourth step ST4. As shown in FIG. 1, in the first step ST1, a positive electrode plate 11, a solid electrolyte layer 12, and a negative electrode plate 13 may be disposed to form and prepare an electrode stacked body 10.

As shown in FIG. 7, in the second step ST2, an electrode stacked body 10 may be in the first penetration hole F11 of the first frame F1 having the first penetration hole F11 corresponding to the outer edge of the electrode stacked body 10. In the second step ST2, a first gap G1 may be formed between the inner surface of the first penetration hole F11 and the outer edge of the electrode stacked body 10. The first gap G1 may enable performance of a warm isostatic press of the edge portion of the electrode stacked body 10.

In the third step ST3, a process sheet may be on both surfaces of the electrode stacked body 10 and the first frame F1 for packing and sealing, thereby forming a process pouch PP. The process pouch PP may enable performance of the warm isostatic press of the edge portion of the electrode stacked body 10 at the first gap G1.

In the fourth step ST4, a pair of second frames F2 having second penetration holes F21 may be on both surfaces of the process pouch PP and may be mutually assembled together to perform a warm isostatic press WIP. A pair of second frames F2 may be mutually fastened by fastening members 41 and 42. At this time, the second frame F2 may touch the first frame F1 through the process pouch PP, but the electrode stacked body 10 may not be pressurized by the second frame F2. A plurality of second penetration holes F21 may be provided to enable performance of the warm isostatic press (WIP) on the process pouch PP supported on the second frame F2.

As an example, since the fastening members 41 and 42 may be formed of bolts and nuts, and mutually fastened through penetration holes 43 and 44 formed in the pair of second frames F2, and the electrode stacked body 10, the first frame F1 and the process pouch PP may be in the pair of second frames F2.

FIG. 10 is an image showing a symmetrical structure at an edge portion (equally applied to an electrode stacked body in a pouch in an all-solid-state battery to which the electrode stacked body is applied) of an electrode stacked body in a process pouch in a state in which a fourth step of FIG. 9 is completed.

Referring to FIG. 10, in the fourth step ST4, the edge portion of the electrode stacked body 10 may be pressurized with the first symmetrical structure that may be vertically symmetrical with respect to the central line CL of the stacking direction. In the fourth step ST4, in the process pouch PP, a process corresponding portion facing the edge portion of the electrode stacked body 10 may be pressurized with a second symmetrical structure that may be vertically symmetrical with reference to the central line to correspond to the first symmetrical structure.

In the fourth step ST4, the upper and lower sides of the process pouch PP adjacent to the inner surface of a pair of second frames F2 may be pressurized toward the central line CL with a slope of a predetermined angle θ. Therefore, the process pouch PP may form a concave structure in the first gap G1. The process pouch PP may form a structure with a recessed portion D2 that may be recessed toward the central line CL.

The first symmetrical structure of the electrode stacked body 10 by the recessed portion D2 of the process pouch PP may allow the pouch 30 to form the recessed portion D that is recessed toward the central line CL if the process pouch PP is removed and assembled on the pouch 30. That is, the recessed portion D of the process pouch PP may form a recessed portion B in the pouch 30 of the all-solid-state battery 100 by the first symmetrical structure if the edge portion of the electrode stacked body 10 is formed of the first symmetrical structure and removed, and then embedded in the pouch 30.

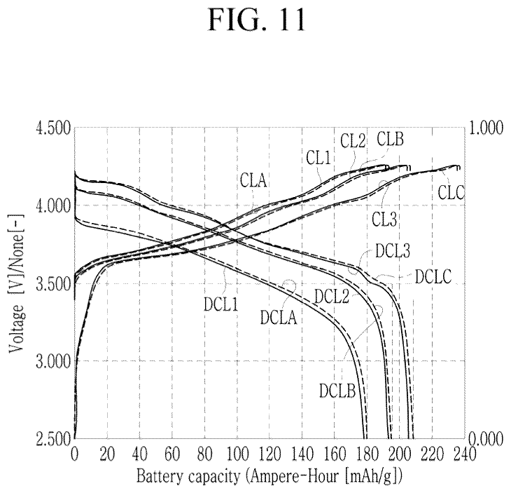

FIG. 11 is a graph comparing characteristic evaluation (battery capacity dominance) for an all-solid-state battery according to an embodiment in which an electrode stacked body forms a symmetrical structure on an edge portion and a comparative example forming an asymmetrical structure.

Referring to FIG. 11, the characteristics of an all-solid-state battery 100 of the symmetrical structure by the symmetrical warm isostatic press (WIP) manufactured by the manufacturing method of an embodiment, and an all-solid-state battery of a nonsymmetrical structure by an asymmetrical warm isostatic press (WIP) of a comparative example are evaluated and compared.

The embodiment of forming the symmetrical structure in the edge portion of the electrode stacked body 10 by the warm isostatic press (WIP) appeared dominant in the battery capacity compared to the comparative example of the asymmetrical structure. That is, a capacitance expressed in an ampere-hour of a horizontal axis at the same voltage of a vertical axis was better in the symmetrical WIP than in the non-symmetrical WIP.

Among right-upward charging curved lines, curved lines CL1 and CLA on the left are cases of charging all-solid-state batteries of a comparative example and an embodiment at 0.1C, among a right-downward discharging curved line, curved lines DCL1 and DCLA on the left are cases of discharging all-solid-state batteries of a comparative example and an embodiment at 0.1C. 0.1C means a speed of slowly charging or discharging the all-solid-state battery for 10 hours.

Among right-upward charging curved lines, the middle curved lines CL2 and CLB are cases of charging the all-solid-state battery of the comparative example and the embodiment at 0.1C, among right-downward discharge curved lines, curved lines DCL2 and DCLB on the left are cases in which the all-solid-state batteries of the comparative example and the embodiment are discharged at 0.33C.

Among right-upward charging curved lines, curved lines CL3 and CLC on the right are cases of charging the all-solid-state battery of the comparative example and the embodiment at 0.1C, among right-downward discharging curved lines, curved lines DCL3 and DCLC on the left are cases in which the all-solid-state batteries of the comparative example and the embodiment are discharged at 1.0C.

In addition, the embodiment of forming the symmetrical structure in the edge portion of the electrode stacked body 10 by the warm isostatic press (WIP) was found to be superior in the internal resistance drop (IR drop) compared to the comparative example.

As a measurement result, the resistance in the all-solid-state battery of the embodiment was represented to be low. As an example, in a DC internal resistance (DC-IR), the embodiment was 554 mΩ, and the comparative example was 592 mΩ. That is, the embodiment appeared lower as 554<592 mΩ compared to the comparative example.

Also, in an AC internal resistance (AC-IR), the embodiment was 0.655 mΩ, and the comparative example was 1.105 mΩ. In other words, the embodiment appeared lower than the comparative example as 0.655<1.105Ω.

By way of summation and review, the all-solid-state battery with the precipitation-type negative electrode plate may not have a housing, and during charging, the lithium ions transferred from the positive electrode plate may be deposited on the negative electrode plate, and during discharging, the lithium ions from the negative electrode plate may be dissociated and transferred to the positive electrode plate.

As such, the all-solid-state battery may adopt the solid electrolyte layer, so the risk of a fire and an explosion may be reduced and the battery capacity may be increased compared to a lithium rechargeable battery using a liquid electrolyte.

However, due to characteristics of the solid electrolyte layer, lithium ion conductivity may be low, so the battery output may be low, and resistance at each interface where the positive electrode plate, the solid electrolyte layer, and the negative electrode plate are in contact with each other may be high, so a pressurization process may be required to lower the internal resistance.

All-solid-state batteries with a sulfide-based solid electrolyte layer may require pressurization at high pressure. One of the methods that may be reviewed as a pressurization process is a warm isostatic press (WIP). The warm isostatic press (WIP) is a method of pressurizing the battery cells with an isostatic pressure at a predetermined temperature, so it may be suitable for all-solid-state batteries including the sulfide solid electrolyte layer as a biaxial press.

However, since the warm isostatic press (WIP) is a method of fixing the battery cells to a metal plate that may be on one side and pressurizing them after vacuum sealing the entire battery cell and metal plate with a process pouch, different pressurization states may be formed on the side with and without the metal plate among two sides of the battery cell. This difference in the pressurization state may form an asymmetrical surface at the edge of the battery cell, thereby degrading the battery capacity and increasing the internal resistance. An embodiment provides an all-solid-state battery in which the electrode stacked body may be formed by pressing the positive electrode plate, the solid electrolyte layer, and the negative electrode plate forms a symmetrical structure with respect to a center line of a stacking direction at the edge portion of the pouch.

An embodiment provides an all-solid-state battery that may improve the battery capacity and may lower the internal resistance by forming the electrode stacked body at the edge portion of the pouch into the symmetrical structure with respect to the center line of the stacking direction.

An embodiment provides a manufacturing method of an all-solid-state battery to have the same pressurized state on both sides of the electrode stacked body by disposing the electrode stacked body to the first penetration hole of the first frame to be packed and sealed with a process pouch, and disposing a pair of second frames on both sides of the process pouch and assembling each other to perform a warm isostatic press (WIP).

In addition, an embodiment provides a manufacturing method of an all-solid-state battery for improving a battery capacity and lowering an internal resistance by providing the same pressure state on both sides of the electrode stacked body for the electrode stacked body to have a symmetrical structure at the edge portion.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid-state battery, comprising:
an electrode stacked body in which a positive electrode plate, a solid electrolyte layer, and a negative electrode plate are stacked;
a gasket provided as a pair in a stacking direction on an outer edge of the electrode stacked body; and
a pouch including a pair of pouch sheets on opposite surfaces of the electrode stacked body and opposite surfaces of the gasket,
wherein the electrode stacked body has a first symmetrical structure that is vertically symmetrical with respect to a central line of the stacking direction at an edge portion in the gasket and the pouch.

2. The all-solid-state battery as claimed in claim 1, wherein the pouch includes a second symmetrical structure that is vertically symmetrical with the central line as a reference so as to correspond to the first symmetrical structure at a corresponding portion facing the edge portion.

3. The all-solid-state battery as claimed in claim 1, wherein the pouch includes a recessed portion of a concave structure on opposite surfaces of the gasket.

4. The all-solid-state battery as claimed in claim 1, wherein the electrode stacked body has a slope of a predetermined angle (6) from upper and lower surfaces adjacent to an inner surface of the pouch toward a central line portion.

5. The all-solid-state battery as claimed in claim 1, wherein:
the positive electrode plate is at a center of the electrode stacked body, and
a positive electrode tab connected to the positive electrode plate is between the gaskets formed as a pair by maintaining a plate shape on the edge portion.

6. The all-solid-state battery as claimed in claim 1, wherein:
the negative electrode plate is on opposite surfaces of the electrode stacked body, and
a negative electrode tab connected to the negative electrode plate is bent into a second symmetrical structure at the edge portion and between the gaskets.

7. A manufacturing method of an all-solid-state battery, the method comprising:
preparing an electrode stacked body in which a positive electrode plate, a solid electrolyte layer, and a negative electrode plate are stacked;
disposing the electrode stacked body in a first penetration hole of a first frame having the first penetration hole corresponding to an outer edge of the electrode stacked body;
disposing a process sheet on opposite surfaces of the electrode stacked body and the first frame, packaging and sealing the electrode stacked body and the first frame to form a process pouch; and
disposing and mutually assembling a pair of second frames having second penetration holes on opposite surfaces of the process pouch to perform a warm isostatic press (WIP).

8. The manufacturing method as claimed in claim 7, wherein an edge portion of the electrode stacked body is pressurized with a first symmetrical structure that is vertically symmetrical with respect to a central line of a stacking direction.

9. The manufacturing method as claimed in claim 8, wherein a process corresponding portion facing the edge portion in the process pouch is pressurized with a second symmetrical structure that is vertically symmetrical with the central line as a reference so as to correspond to the first symmetrical structure.

10. The manufacturing method as claimed in claim 7, wherein a first gap is formed between an inner surface of the first penetration hole and the outer edge of the electrode stacked body.

11. The manufacturing method as claimed in claim 10, wherein an edge portion of the electrode stacked body is pressurized with a slope of a predetermined angle (θ) with respect to a central line portion by receiving the warm isostatic press (WIP) from upper and lower sides adjacent to the inner surface of the second frame of the process pouch.
